(19) United States
(12) Patent Application Publication
(10) Pub. No.: US 2009/0170971 A1
(43) Pub. Date: Jul. 2, 2009

(54) METHOD FOR MANUFACTURING STARCH FOAM

(75) Inventors: Jyi Hsiang Lee, Hsinchu (TW); Chei Kao, Hsinchu (TW); Ching-Chih Lai, Hsinchu (TW); Chin-Ying Tsai, Hsinchu (TW)

Correspondence Address: PAI PATENT & TRADEMARK LAW FIRM, 1001 FOURTH AVENUE, SUITE 3200, SEATTLE, WA, 98154, US

(73) Assignee: INDUSTRIAL TECHNOLOGY RESEARCH INSTITUTE, Hsinchu County (TW)

(21) Appl. No.: 12/118,693

(22) Filed: May 10, 2008

(30) Foreign Application Priority Data
Dec. 27, 2007 (TW) 96150509

(51) Int. Cl. C08J 9/00; C08B 30/00

(52) U.S. Cl. 521/84.1; 127/65

(57) ABSTRACT

A method for manufacturing a starch foam is provided. A mixture is mixed to form a foamable mixture. The mixture includes a starch, a nucleating agent, and a foaming agent. The foamable mixture is foamed to form a foam. The starch includes a cereal or a root crop. The cereal includes rice, wheat or corn. The root crop includes cassava, sweet potato or potato.

### BACKGROUND OF THE INVENTION

1. Field of the Invention

The present invention relates to a method for manufacturing a starch foam.

2. Description of the Related Art

The Waste Electrical and Electronic Equipment (WEEE) Directive (European Community directive 2002/96/EC) and the Restriction of Hazardous Substance (ROHS) Directive (European Community directive 2002/95/EC) have been published by European Union (EU) since 2003, and obliges EU member states to transpose its provisions into national law for setting collection, recycling and recovery targets for all types of electrical goods. As of July 2006, the maximum weight for substances of lead, mercury, cadmium, chromium (VI), polybrominated biphenyls (PBB) and polybrominated diphenyl ethers(PBDE) are prohibited by the RoHS Directive. If the substances of the electronic equipments exceed the limit, the electronic equipments can not be imported into the EU member states. Manufacturing products in consideration of environmental consciousness (or so-called “green products”) is a major subject for the manufacturing industry. For green products, all parts of a product must conform to the proper directives. As such, manufacturing techniques specifically geared toward green products have increased demand due to environmental consciousness.

With conventional plastics seldom self-decomposing, they cause environmental issues when discarded. Thus, degradable plastics have been imported, researched and manufactured in many countries. Recently, developed countries have increased research for eco-materials, such as environmental friendly materials. Meanwhile, cheap materials, such as PVC and EPS, are the main materials previously used for packaging. Since PVC contains chlorine, it causes an environment issue during its whole life cycle, such as during production, use, and when discarded. PVC is called a “poison plastic” by Greenpeace International, and is deemed not fit for environmental demands. Thus, PVC has been substituted by polyolefin. However, no suitable material has been developed, that would feasibly be a substitute for ESP. Thus, increased methods for manufacturing and modeling materials which can be popularly or specially applied have to be developed to meet demands for lower costs, recycling capabilities and environmental consciousness.

A method for manufacturing a starch foam is thus desirable.

### BRIEF SUMMARY OF INVENTION

A detailed description is given in the following embodiments with reference to the accompanying drawings.

The invention provides a method for manufacturing a starch foam. An embodiment of a method for manufacturing a starch foam includes mixing a mixture to form a foamable mixture. The mixture includes a starch, a nucleating agent, and a foaming agent. The foamable mixture is foamed to form a foam.

Another embodiment of a method for manufacturing a starch foam includes mixing a mixture to form a foamable mixture. The mixture includes a cereal or a root crop, a nucleating agent, and a foaming agent. The foamable mixture is mold press foamed to form a foam.

Yet another embodiment of a method for manufacturing a starch foam includes mixing a mixture to form a foamable mixture. The mixture includes a cereal or a root crop, a nucleating agent, and a foaming agent. The foamable mixture is extrusion foamed to form a foam.

### BRIEF DESCRIPTION OF DRAWINGS

The present invention can be more fully understood by reading the subsequent detailed description and examples with references made to the accompanying drawings, wherein:

FIG. 1 is a schematic view showing the biodegradation test system according to an embodiment of the invention.

### DETAILED DESCRIPTION OF INVENTION

A method for manufacturing a starch foam of embodiments of the present invention is described in detail as follows. A mixture is mixed to form a foamable mixture. The mixture includes a starch, a nucleating agent, and a foaming agent. Then, the foamable mixture is foamed to form a foam. The starch includes a cereal or a root crop. The cereal includes rice, wheat, corn or other natural cereal plants. The root crop includes cassava, sweet potato, potato or other natural root crop plants. In addition to the cereal and the root crop, the starch also includes any plants having starch elements. The nucleating agent includes calcium carbonate, calcium hydroxide, silicate or other suitable nucleating agents. A weight of the nucleating agent is 0.1 to 20 based on a weight of the starch of 100. The foaming agent includes water, carbon dioxide, nitrogen, oxygen, air, alcohol or other suitable foaming agents. A weight of the foaming agent is 0.1 to 20 based on the weight of the starch of 100.

In addition to the starch, the nucleating agent, and the foaming agent, the mixture may further include a crosslinking agent, an additive and/or a plasticizing agent. The crosslinking agent includes dialdehyde monomer, such as 1,5-pentandeial, anhydride monomer, such as octenyl succinic anhydride, acrylic monomer or other suitable crosslinking agent. A weight of the crosslinking agent is 0 to 10 based on the weight of the starch of 100. The additive includes polyvinyl alcohol or other suitable additives. A weight of the additive is 0 to 50 based on the weight of the starch 100. The plasticizing agent includes glycerol or other suitable plasticizing agents. A weight of the plasticizing agent is 0 to 30 based on the weight of the starch of 100. The plants having starch elements, such as the cereal or the root crop, are the main material used for manufacturing the foam, thus avoiding environmental pollution issues.

In addition to the main material having starch elements such as the cereal or the root crop, the mixture includes the nucleating agent and the foaming agent, or appropriately further includes the additive, the plasticizing agent and/or the crosslinking agent. The mixture is mix to form the foamable mixture. The weighted starch and the weighted nucleating agent are put into a high speed mixer. After mixing with a high speed of 3000 rpm for 1 minute and then waiting for 5 minutes, the foaming agent, or appropriately the additive, the plasticizing agent and/or the crosslinking agent are put into the high speed mixture. Then the mixing is performed by mixing with a high speed of 3000 rpm for 3 minutes, waiting for 5 minutes, mixing with a high speed of 3000 rpm for 3 minutes, waiting for 5 minutes, mixing with a high speed of 3000 rpm for 3 minutes and waiting for 10 minutes, in sequence. Therefore the mixture is mixed to form the foamable mixture.

Next, the foamable mixture is foamed to form the foam. The foaming step includes mold press foaming or extrusion foaming. The mold compression foaming step includes pressing the foamable mixture, weighted by the electronic control system, into a mold by a hydraulic press system, and then mold compression foaming the foamable mixture at a pressure of 20-100 kg/cm² and a temperature of 120-180° C. to form the foam. The extrusion foaming step includes kneading the foamable mixture into the grainy by a twin-screw extruder, and then extrusion foaming the grainy foamable mixture to form the foam by a single-screw extruder at a temperature of 120-180° C.

The following description is of the best-contemplated mode of carrying out the invention. This description is made for the purpose of illustrating the general principles of the invention and should not be taken in a limiting sense. The scope of the invention is best determined by reference to the appended claims.

### EXAMPLE 1

Grainy wheat, calcium hydroxide of the nucleating agent, polyvinyl alcohol of the additive, and water of the foaming agent were well mixed with a ratio as shown in Table 1 to form the foamable mixture. The foamable mixture was then kneaded into the grainy material by the twin-screw extruder. Next, the grainy foamable mixture was extrusion foamed to form the foam by using the single-screw extruder, having a diameter of about 76 mm and a length of about 260 mm, at a temperature of 120-180° C. The result of the example 1 is shown in table 4.

### EXAMPLE 2

Powdery rice, calcium carbonate of the nucleating agent, glycerol of the plasticizing agent, and water of the foaming agent were well mixed with a ratio as shown in Table 2 to form the foamable mixture. The foamable, weighted by the electronic control system, was pressed into the mold by using the hydraulic press system. Next, the foamable mixture was mold compression foamed form the foam at the pressure of 20-100 kg/cm² and the temperature of 120-180° C. The result of the example 2 is shown in Table 4.

### EXAMPLE 3

Powdery rice, calcium carbonate of the nucleating agent, glycerol of the plasticizing agent, 1,5-pentandeial of the crosslinking agent, and water of the foaming agent with a ratio as shown in Table 3 were well mixed to form the foamable mixture. The foamable, weighted by using the electronic control system, was then pressed into the mold by using the hydraulic press system. Next, the foamable mixture was mold compression foamed to form the foam at the pressure of 20-100 kg/cm² and the temperature of 120-180° C. The result of the example 3 is shown in Table 4.

### Experimental Result

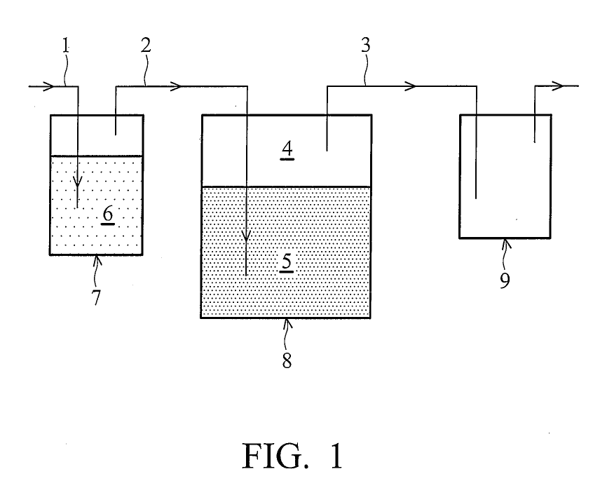

The experimental results, illustrated in Table 4, show that the compressive strength of the foams formed by the methods according to the examples is stronger than that of the ESP. Thus, the foams formed by the methods according to the examples withstood higher stress. Biodegradation tests were performed according to the CNS144321 national standard. The ESP and the foams of the examples 1, 2, and 3 were tested for the aerobic biodegradation and the disintegration, and analyzed for carbon dioxide liberation, in the muck environment by the method as shown in FIG. 1. An air 1 flowed into a de-carbon dioxide system 7 containing a sodium hydroxide solution 6 to form an air without carbon dioxide 2. The air without carbon dioxide 2 flowed into a muck container 8 containing a test compound 5, and was decomposed by the test compound 5 to form an air with carbon dioxide 3. The air with carbon dioxide 3 was tested for the quantity of carbon dioxide by a carbon dioxide test system 9. The test foams were put in the muck container 8 at a stable temperature of 58±2 □ and isolated from vapor that may affect the organism. The test was designed for the conversion ratio of the carbon elements of the test foams into the carbon dioxide. The duration of the test was generally 180 days. The biodegradations of the foams, formed by the methods according to the examples 1, 2, and 3, were 70% in the duration of only 45 days. Thus, the foams were defined as being biodegradable according to the national standard. However, the biodegradation of the conventional ESP was lower than 10% in the duration of 180 days, thus showing that the conventional ESP does affect the global environment. Since the foams of the invention are manufactured using the cereal or the root crop of natural plants by the method according to the invention, the foams of the invention do not cause environmental pollution issues.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

TABLE 1
The components of the mixture for the example 1

| component | Weight |
|---|---|
| (grainy) wheat | 80 |
| calcium hydroxide | 5 |
| polyvinyl alcohol | 15 |
| water | 15 |

TABLE 2
The components of the mixture for the example 2

| component | weight |
|---|---|
| (powdery) rice | 100 |
| calcium carbonate | 8 |
| glycerol | 5 |
| water | 30 |

TABLE 3
The components of the mixture for the example 3

| component | weight |
|---|---|
| (powdery) rice | 100 |
| calcium carbonate | 8 |
| glycerol | 5 |
| 1,5-pentandeial | 3 |
| water | 30 |

TABLE 4
Characteristics of ESP, and foams formed by the method according
to the example 1, 2, and 3.

| | EPS | Example 1 | Example 2 | Example 3 |
|---|---|---|---|---|
| density(g/cm3) | 0.021 | 0.055 | 0.213 | 0.182 |
| moisture content | 0.70 | 8.5 | 7.2 | 5.3 |
| (%) | | | | |
| PH value | 7.2 | 7.0 | 7.0 | 6.8 |
| dimension | +0.4 | +0.8 | +0.6 | +0.3 |
| change (%) | | | | |
| compressive | 2.18 | 2.48 | 2.82 | 5.73 |
| strength (kgf/cm2) | | | | |
| biodegradation | <10/180 | >70/45 | >70/45 | >70/45 |
| (%/day) | | | | |

What is claimed is:

1. A method for manufacturing a starch foam, including:
mixing a mixture to form a foamable mixture, wherein the mixture includes a starch, a nucleating agent, and a foaming agent; and
foaming the foamable mixture to form a foam.

2. The method for manufacturing the starch foam as claimed in claim 1,
wherein the starch includes a cereal or a root crop.

3. The method for manufacturing the starch foam as claimed in claim 2,
wherein the cereal includes rice, wheat or corn.

4. The method for manufacturing the starch foam as claimed in claim 2,
wherein the root crop includes cassava, sweet potato or potato.

5. The method for manufacturing the starch foam as claimed in claim 1,
wherein the mixture further includes an additive, a plasticizing agent and/or a crosslinking agent.

6. The method for manufacturing the starch foam as claimed in claim 5,
wherein the crosslinking agent includes dialdehyde monomer, anhydride monomer or acrylic monomer.

7. The method for manufacturing the starch foam as claimed in claim 5,
wherein the additive includes polyvinyl alcohol.

8. The method for manufacturing the starch foam as claimed in claim 5,
wherein the plasticizing agent includes glycerol.

9. The method for manufacturing the starch foam as claimed in claim 1,
wherein the foaming agent includes water, carbon dioxide, nitrogen, oxygen, air or alcohol.

10. The method for manufacturing the starch foam as claimed in claim 1,
wherein the nucleating agent includes calcium carbonate, calcium hydroxide or silicate.

11. The method for manufacturing the starch foam as claimed in claim 1,
wherein the foaming step includes mold press foaming.

12. The method for manufacturing the starch foam as claimed in claim 11,
wherein the mold press foaming step is performed at a temperature of 120-180 □.

13. The method for manufacturing the starch foam as claimed in claim 11,
wherein the mold press foaming step is performed under a pressure of 20-100 kg/cm².

14. The method for manufacturing the starch foam as claimed in claim 1,
wherein the foaming step includes extrusion foaming.

15. The method for manufacturing the starch foam as claimed in claim 14,
wherein the extrusion foaming step is performed by using a single-screw extruder.

16. The method for manufacturing the starch foam as claimed in claim 15,
wherein the extrusion foaming step is performed at a temperature of 120-180 □.

17. The method for manufacturing the starch foam as claimed in claim 15,
further including kneading the foamable mixture into a grainy by using a twin-screw extruder after the mixing step or before the extrusion foaming step.

18. A method for manufacturing a starch foam, including:
mixing a mixture to form a foamable mixture, wherein the mixture includes a cereal or a root crop, a nucleating agent, and a foaming agent; and
mold press foaming the foamable mixture to form a foam.

19. The method for manufacturing the starch foam as claimed in claim 18,
wherein the mixture further includes an additive, a plasticizing agent and/or a crosslinking agent.

20. The method for manufacturing the starch foam as claimed in claim 19,
wherein the crosslinking agent includes dialdehyde monomer, anhydride monomer or acrylic monomer.

21. The method for manufacturing the starch foam as claimed in claim 19,
wherein the additive includes polyvinyl alcohol.

22. The method for manufacturing the starch foam as claimed in claim 19,
wherein the plasticizing agent includes glycerol.

23. The method for manufacturing the starch foam as claimed in claim 18,
wherein the cereal includes rice, wheat or corn.

24. The method for manufacturing the starch foam as claimed in claim 18,
wherein the root crop includes cassava, sweet potato or potato.

25. The method for manufacturing the starch foam as claimed in claim 18,
wherein the nucleating agent includes calcium carbonate, calcium hydroxide or silicate.

26. The method for manufacturing the starch foam as claimed in claim 18,
wherein the foaming agent c includes water, carbon dioxide, nitrogen, oxygen, air or alcohol.

27. The method for manufacturing the starch foam as claimed in claim 18,
wherein the mold press foaming step is performed at a temperature of 120-180° C.

28. The method for manufacturing the starch foam as claimed in claim 18,
wherein the mold press foaming step is performed under a pressure of 20-100 kg/cm².

29. A method for manufacturing a starch foam, including:
mixing a mixture to form a foamable mixture, wherein the mixture includes a cereal or a root crop, a nucleating agent, and a foaming agent; and
extrusion foaming the foamable mixture to form a foam.

30. The method for manufacturing the starch foam as claimed in claim 29,
wherein the mixture further includes an additive, a plasticizing agent and/or a crosslinking agent.

31. The method for manufacturing the starch foam as claimed in claim 30,
wherein the crosslinking agent includes dialdehyde monomer, anhydride monomer or acrylic monomer.

32. The method for manufacturing the starch foam as claimed in claim 30,
wherein the additive includes polyvinyl alcohol.

33. The method for manufacturing the starch foam as claimed in claim 30,
wherein the plasticizing agent includes glycerol.

34. The method for manufacturing the starch foam as claimed in claim 29,
wherein the cereal includes rice, wheat or corn.

35. The method for manufacturing the starch foam as claimed in claim 29,
wherein the root crop includes cassava, sweet potato or potato.

36. The method for manufacturing the starch foam as claimed in claim 29,
wherein the nucleating agent includes calcium carbonate, calcium hydroxide or silicate.

37. The method for manufacturing the starch foam as claimed in claim 29,
wherein the foaming agent includes water, carbon dioxide, nitrogen, oxygen, air or alcohol.

38. The method for manufacturing the starch foam as claimed in claim 29,
wherein the extrusion foaming step is performed by using a single-screw extruder.

39. The method for manufacturing the starch foam as claimed in claim 38,
wherein the extrusion foaming step is performed at a temperature of 120-180° C.

40. The method for manufacturing the starch foam as claimed in claim 38,
further including kneading the foamable mixture into a grainy by using a twin-screw extruder after the mixing step or before the extrusion foaming step.
